(19) United States
(12) Patent Application Publication
(10) Pub. No.: US 2015/0128717 A1
(43) Pub. Date: May 14, 2015

(54) AUTOMATED DYNAMIC LASER BOND INSPECTION SYSTEM

(71) Applicants: Gary J. May, Plain City, OH (US); Jeff L. Dulaney, Delaware, OH (US); Keith Glover, Dublin, OH (US)

(72) Inventors: Gary J. May, Plain City, OH (US); Jeff L. Dulaney, Delaware, OH (US); Keith Glover, Dublin, OH (US)

(21) Appl. No.: 14/541,137

(22) Filed: Nov. 13, 2014

Related U.S. Application Data
(60) Provisional application No. 61/903,584, filed on Nov. 13, 2013.

(51) Int. Cl. G01N 19/04; G01B 11/16; G01N 3/08

(52) U.S. Cl. CPC G01N 19/04; G01N 3/08; G01B 11/16
USPC 73/800

(57) ABSTRACT

Methods, systems, and apparatuses are disclosed for automated dynamic laser bond inspection of a bonded article.

This application claims priority from U.S. Provisional Patent Application No. 61/903,584, filed on Nov. 13, 2013, which is incorporated by reference herein in its entirety.

### BACKGROUND

Bonded materials are used in a variety of structural applications. For example, adhesively bonded, laminated composite structures are increasingly being used in aircraft construction to reduce weight, reduce or eliminate the number of separate components, reduce fabrication costs, and improve fuel efficiency. The presence of material defects in a composite aircraft structure can lead to disastrous failure of the structure under flight loads. These defects may exist in the composite laminate itself, as well as in the adhesive bonds in the structure. The defects may arise as a result of damage during service, or in the original manufacturing process.

The growing ubiquity of composite structures has led to an increased need for techniques to evaluate the strength of the composite structures, including the adhesive bonds themselves, without damaging or destroying the composite structures. Conventional nondestructive evaluation (“NDE”) techniques are useful when a gap, crack, or void is present in a bonded material. However, conventional NDE techniques do not adequately identify deficiencies, such as weak bonds or “kissing bonds,” where materials bonded together are in contact but without adequate structural strength. These deficiencies can result from bond surface contamination, improperly mixed or outdated adhesives, improper adhesive curing, and improper adhesive application.

Laser bond inspection (“LBI”) is an NDE technique for testing the integrity of bonded materials and structures. LBI comprises sending a precisely controlled dynamic stress wave through an adhesive bond of a composite structure. Generally speaking, and with reference to FIG. 1, LBI 100 comprises the deposition of laser energy 102 at a first surface 106 of a bonded material 104, generating a compressive stress wave 108. A first laser pulse 102 is applied to first surface 106 after an opaque overlay 112 and a transparent (tamping) overlay 110 are applied to surface 106. Laser pulse 102 passes through transparent overlay 110 and is absorbed by opaque overlay 112. A plasma is created and as the plasma blows off, compressive stress wave 108 is induced into surface 106. Generally speaking, no intentional heating occurs in the composite structure, and surface damage is attempted to be avoided. The shape of stress wave 108 can be tailored to a few hundred nanoseconds in duration. The magnitude of stress wave 108 is a function of the laser input irradiance, which facilitates generation of calibrated stress waves. Compressive stress wave 108 propagates through bonded material 104, through a bond of interest 114, to a second surface 116 of bonded material 104, where stress wave 108 is reflected from the back surface as a tensile wave (not shown). The tensile wave propagates back through bonded material 104 and, when the tensile wave reaches bond 114, the tensile wave stresses bond 114. The application of dynamic stress on bonded material 104 is low enough to have little or no effect on the integrity of bonded material 104 or bond 114 if bond 114 is sufficiently strong. However, if bond 114 is below a suitable strength, the tensile wave will cause bond 114 to fail (or will expose its non-bonded nature, in the case of a “kissing bond”). A surface motion sensor such as one of: a VISAR probe; an electromagnetic acoustic transducer (EMAT) coil; a capacitance probe; a piezoelectric ultrasonic transducer (UT); a photon Doppler velocimeter; and any other optical interferometer, may be used to detect surface motion caused by the tensile wave. By observing changes in the surface motion, a determination can be made on the strength and reliability of the bond.

Current LBI equipment is large, and the bonded article must either be positioned to align with the LBI equipment or the LBI equipment must be manually positioned vis-a-vis each bond prior to inspection. While manual positioning of the bonded article and LBI equipment is acceptable for relatively small, bonded parts, the use of such LBI techniques is more challenging with larger structures such as aircraft wings, fuselage components, wind turbine blades, bridge and building structures, and the like. U.S. Pat. Nos. 6,288,358; 6,528,763; 6,867,390; 7,770,454; and 8,156,811 (all to LSP Technologies, Inc.), all of which are incorporated herein by reference in their entireties, disclose improvements to laser system mobility.

What is needed is an automated and dynamic system and apparatus for laser bond inspection of a bond in a bonded article.

### SUMMARY

Systems and methods are provided for automated laser bond inspection of a bond in a bonded article.

In one embodiment, a system for non-destructively inspecting a bond in a bonded article is provided, the system comprising: a laser beam delivery system operable to deliver a laser beam from a laser to a workpiece for laser bond inspection of a bonded article, and a dynamic platform system, operable to move one or more components of the laser beam delivery system in one or more axes of translation and one or more axes of rotation.

In another embodiment, an automated and dynamic system for laser bond inspection of a bond in a bonded article is provided, the system comprising: (1) a laser, the laser configured to generate a pulsed laser beam; (2) a laser beam delivery system operatively connected to the laser and operable to deliver the pulsed laser beam to at least one of: a workpiece surface, and a processing head; (3) a surface motion sensor, the surface motion sensor configured to detect a surface motion on the workpiece surface during the laser bond inspection; (4) a dynamic platform system operable to support and move one or more components of the automated and dynamic system for laser bond inspection; and (5) a control system comprising at least one of: one or more processors, and one or more controllers, wherein the control system is operable to execute an instruction set, process input and output signals, and control one or more components of the automated and dynamic system for laser bond inspection.

A method for automated non-destructive testing of a bond in a bonded article is provided, the method comprising: (1) defining coordinates of a first bond and subsequent bonds in a series of bonds and/or a first bond location and subsequent bond locations in a single bond in a bonded article; (2) automatically positioning a laser beam in relation to the coordinates; (3) lasing a surface of the bonded article with a pulsed laser beam in a low-high-low pulsed energy sequence, each pulse having a pulse energy of between about 3 J and about 50 J; (4) detecting surface motion on the bonded article; and (5) repeating steps 3-4 after repositioning the laser beam to the coordinates of a subsequent bond in the series of bonds and/or a subsequent bond location in the single bond.

In one embodiment, an automated dynamic LBI system can test composite to composite bonds, metal to metal bonds, and composite to metal bonds.

In another embodiment, an automated dynamic LBI system is self-contained and sits on a mobile platform to facilitate rapid insertion of the LBI process into manufacturing plant operations or maintenance depots.

In another embodiment, an automated dynamic LBI system is automated to inspect bonded materials with minimal manual movements providing improved test repetition, improved test accuracy, and reduced LBI operational cost.

In another embodiment, an automated dynamic LBI system is automated to both position a processing head and facilitate movement of a laser and a laser beam delivery system around a large structure, so that a processing head may be automatically positioned on different parts of a large structure without requiring movement of the large structure to position the processing head.

### BRIEF DESCRIPTION OF THE DRAWINGS

The accompanying figures, which are incorporated in and constitute a part of the specification, illustrate example systems and methods, and are used merely to illustrate example embodiments.

FIG. 1 illustrates a schematic of an example initiation of the laser bond inspection process.

FIG. 2 illustrates an example arrangement of a laser bond inspection system.

FIG. 3 illustrates a dynamic platform of an automated dynamic laser bond inspection system.

FIG. 4 illustrates a schematic arrangement of a dynamic platform.

FIG. 5 illustrates an example arrangement of an automated dynamic laser bond inspection system.

FIG. 6 illustrates an alternative embodiment of an automated dynamic laser bond inspection system.

FIG. 7 is a flow chart of an example method for automated non-destructive testing of a bond in a bonded article.

### DETAILED DESCRIPTION

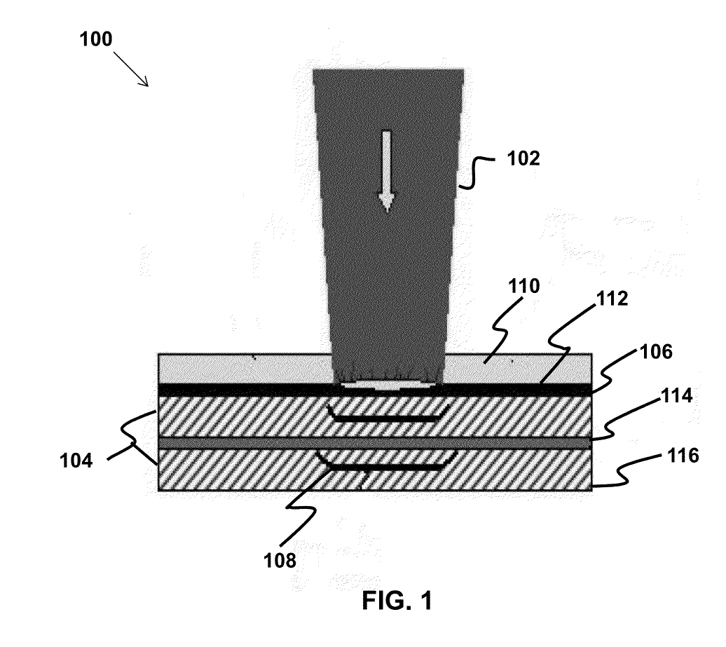

The embodiments claimed herein disclose using an automated dynamic laser bond inspection system for inspecting a bond in a bonded article. With reference to FIG. 1, a system 200 for non-destructively inspecting a bond in a bonded article 210 is provided, system 200 comprising: a laser 220; one or more laser feedback sensors 222; a laser beam delivery system 230; one or more laser beam delivery feedback sensors 232; a processing head 240; one or more processing head sensors 242; and a surface motion sensor 250. In one embodiment, laser system 200 may include fixed laser 220 and laser beam delivery system 230 and may not include processing head 240.

In one embodiment, laser 220 may comprise, for example, a neodymium glass laser, such as, for example, those manufactured by LSP Technologies, Inc., a YAG laser, a YLF laser, or any other solid-state crystal material, in either a rod or a slab gain medium. Laser 220 may be configured to deliver laser pulses having a pulse energy of between about 3 J and about 50 J (at the output of the final amplifier module), a wavelength of about 1 μm, and a pulse width of between about 100 ns and 300 ns, and further being configured to deliver the laser pulses in a low-high-low or probe-break-probe pulse energy sequence (i.e., a first laser pulse have a first energy, a second laser pulse having a second energy that is greater than the first energy but less than an energy required to break a properly constructed or “good” bond, and a third laser pulse having an energy which is approximately the same as the first pulse's energy), as described and illustrated in U.S. Pat. Nos. 7,770,454 and 8,156,811. LBI uses a laser pulse width of about 70 ns to about 300 ns. Beam diameter of LBI is selected as a compromise between the need to have a large area for planar wave generation and a reasonable sized beam for the inspection of small zones in the object. A beam size of about 10.0 mm is a suitable compromise. The use of a large diameter laser beam of several mm or more generates suitable internal stress for the evaluation of internal bonds and avoids surface spallation of a bonded article under LBI. Fluence is a measure of energy delivered per unit area, and LBI uses fluence values ranging between about 4 J/cm² to about 6 J/cm² for the interrogation of weak bonds, while medium strength bonds fail around about 16 J/cm². Further configurations of laser 220 may include those described and illustrated in U.S. Pat. Nos. 7,770,454 and 8,156,811.

In one embodiment, laser beam delivery system 230 may comprise, for example, at least one of: (a) one or more mirrors; (b) an articulated arm; and (c) one or more fiber optics (also referred to as an optical fiber), and includes the laser beam delivery systems described and illustrated in U.S. Pat. Nos. 7,770,454 and 8,156,811. In one embodiment, where laser beam delivery system 230 is one or more mirrors, the beam may be directed to the surface of bonded article 210 without need for processing head 240. In alternative embodiments, where laser beam delivery system 230 is an articulated arm and fiber optics, laser beam delivery system 230 may be operatively connected to processing head 240.

In one embodiment, surface motion sensor 250, such as an EMAT coil, may be integrated in processing head 240. In another embodiment, surface motion sensor 250 may be separate from processing head 240 like a remote optical interferometer such as a VISAR device. In another embodiment, surface motion sensor 250 may be a Doppler velocimeter.

Additionally, processing head 240 may include a first output (not shown) to output a laser beam if processing head is operatively connected to laser beam delivery system 230, and second output (not shown) to output one or more overlays such as: a transparent overlay, an opaque overlay, an inspection coupon, a metal foil. Processing head may include one or more suction ports (not shown) to vacuum debris generated during a laser bond inspection process proximate to processing head 240 and workpiece surface, and be used for vacuum attachment of processing head 240 to a workpiece.

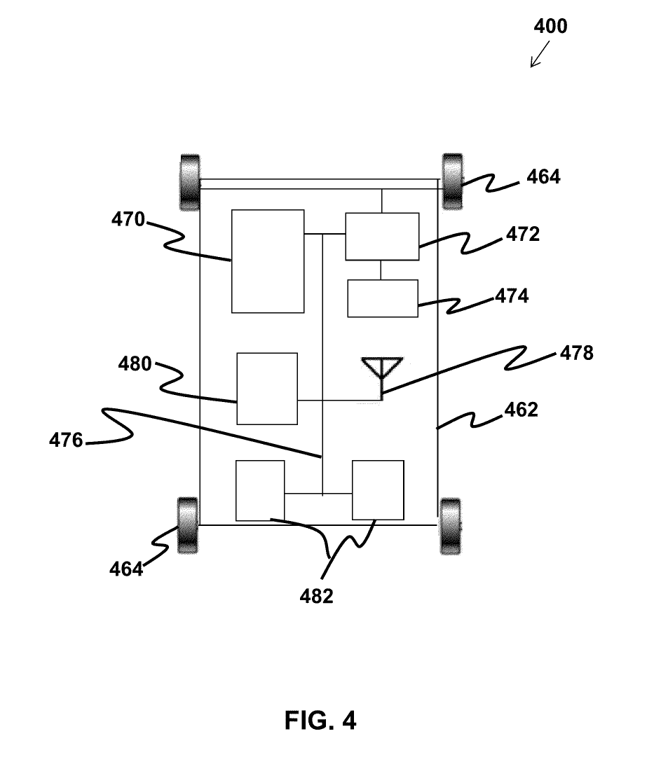

Laser feedback sensor 222, laser beam delivery feedback sensor 232, and processing head sensor 242 may provide feedback to control units, e.g., control units 472 and 474, as depicted in and described herein with respect to FIG. 4. Laser feedback sensor 222, laser beam delivery feedback sensor 232, and processing head sensor 242 may be, but are not limited to any or all of: spatial position sensors, location position sensors, displacement sensors, alignment sensors, tilt sensors, cameras, optical sensors, phototransistors, accelerometers, Global Positioning System (GPS), magnetometers, gyroscopes, pressure sensors, gas sensors, voltage and current sensors, capacitive touch sensors, color detection, light detection, force sensors, infrared (IR) emitters/detectors, radio-frequency identification (RFID) sensors, laser beam profiler, potentiometers, thermistors, temperature and humidity sensors, ultrasonic rangefinders and echo location sensors, laser positioning, video imagining sensors, and the like. In one embodiment, feedback from sensors 222, 232, and 242 is used by, e.g., control units 472 and 474 to assist in automated dynamic LBI. In one embodiment, laser feedback sensor 222 may be a laser beam profiler which communicates laser beam parameters to, e.g., control units 472 and 474. If feedback data from laser feedback sensor 222 is out of the control limits defined by an automated process, control units, e.g., control units 472 and 474 may output control signals to laser 220 to produce a laser beam within proper parameters. In another embodiment, laser beam delivery feedback sensor 232 may be a position sensor sending laser beam delivery system position data to, e.g., control units 472 and 474. In response to a detected change in laser beam delivery system position data, control units, e.g., control units 472 and 474 may output a control signal to laser beam delivery system 230 to adjust mirrors based on new position data for proper operation of laser beam delivery system 230.

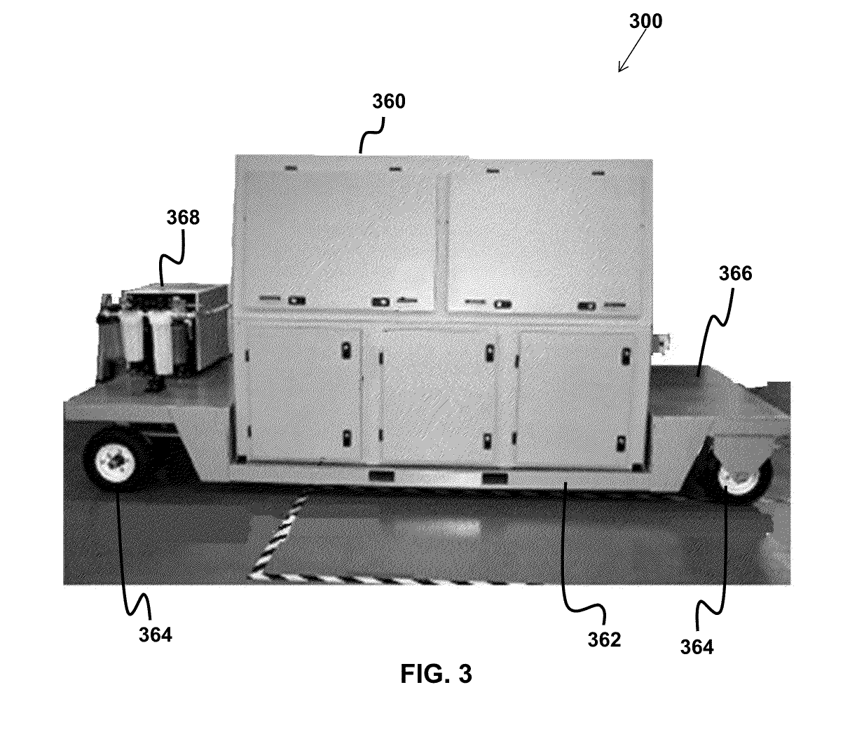

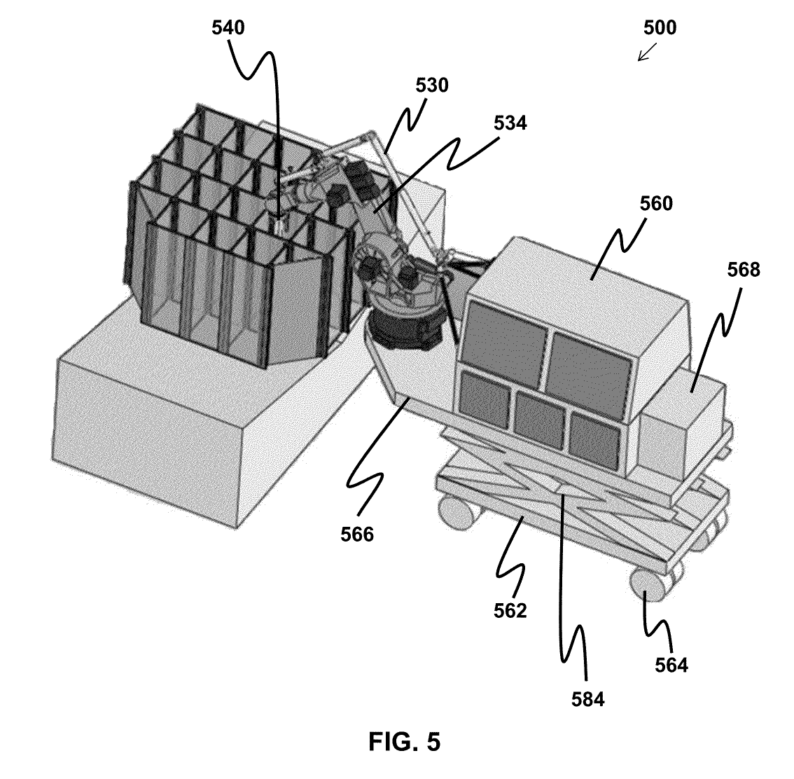

With reference to FIG. 3, an embodiment of a dynamic platform 300 of an automated dynamic LBI system is shown. Dynamic platform 300 comprises a cabinet housing 360 which contains one or more components of an LBI system, e.g., LBI system 200. Housing 360 is operatively connected to a chassis 362. Chassis 362 may have one or more movement devices 364 for facilitating movement of dynamic platform 300. Chassis 362 may include one or more platform areas 366. Platform areas 366 may be used to mount an articulated arm and/or laser beam delivery system, e.g., an articulated arm 534 and/or laser beam delivery system 530, as depicted in and described herein with respect to FIG. 5. Platform area 366 may also be used to mount integral parts of the LBI system 200 such as chiller 368, where chiller 368 is better suited in an open environment for heat exchange purposes than inside housing 360. As used herein, components of an automated and dynamic system for laser bond inspection may refer generally to, and may include any and all of: a laser, a laser beam delivery system, a processing head, a surface motion sensor, a dynamic platform, and a control system. As also used herein, movement of an automated and dynamic system for laser bond inspection may be translational—that is along one of an x, y, or z axis, or rotational—that is, rotate about an x, y, or z axis.

With reference to FIG. 4, a schematic view of dynamic platform 400 is shown. Chassis 462 is of a strong, durable material, such as steel, and chassis material selection may be based on various build specifications depending on the intended use of dynamic platform 400. In one embodiment, where chassis 462 is intended for ground use, chassis 462 may be one of: a truck, a trailer, a cart, a wagon, a trolley, or the like. In one embodiment, chassis 462 may be a lowboy trailer design to accommodate and better distribute the weight of an LBI system, e.g., LBI system 200. Chassis 462 may be self-propelled or towed/pushed from another vehicle. In one embodiment, a self-propelled chassis 462 is powered from a common locomotive drive source 470 such as a combustion engine, an electric motor, or the like. In one embodiment, drive source 470 may be powered from a low-emissions energy source well suited for use in manufacturing plants and maintenance depots such as: a battery powered traction motor; an electric motor; a liquefied propane gas (LPG) engine; a compressed air driven pneumatic motor or the like.

Chassis 462 contains one or more movement devices 464. Movement devices 464 may be one of: a wheel; a continuous track caterpillar tread; a railroad bogie or the like, and may be suited to a specific application of dynamic platform 400. In one embodiment, movement device 464 may interface with one of: a rail system, a track, and a guide in a floor or mounted on the wall and ceiling of a facility such that dynamic platform 400 is guided around the facility via rail, track, and guide. In one embodiment, movement device 464 may be operatively connected to drive source 470. In one embodiment, movement device 464 is a combination of pivotable steering wheels and fixed drive wheels connected to an electronic control unit (ECU) 472 which controls power from drive source 470 to each drive wheel to provide dynamic platform 400 with a low turning radius steering capability. A dynamic platform 400 with a low turning radius is advantageous for use in a manufacturing facility or maintenance depot where space concerns may require precise turning and increased maneuverability.

Dynamic platform 400 is intended for automated operation in conjunction with an LBI system, e.g., LBI system 200. A control system for controlling dynamic platform 400 may include one or more controllers 472, 474, and one or more processors (not shown). Control system may be operable to execute an instruction set (i.e. programs), process input and output signals (i.e. from sensors), and control one or more components of the automated and dynamic system for laser bond inspection. Controllers 472, 474 may be controllers used in process control such as a programmable logic controller (PLC). In one embodiment, ECU 472 may be programmed to provide automated operation of dynamic platform 400 and LBI 200. Additionally, ECU 472 and one or more control units 474 may be programmed to provide specific automation functions such as laser control, laser beam delivery control, articulated arm control, processing head control, lift control, steering control, drive source control, etc. ECU 472 and one or more control units 474 may be selected from con In one embodiment, all automation is controlled by ECU 472. In another embodiment, one or more control units 474 may be used to control each specific automated function. Control units 472 and 474 may be electrically connected to other devices on dynamic platform 400 by a bus system 476. Bus system 476 may be any communications network capable of interconnecting electrical components known in the art such as: a wire harness; a CAN Bus; D2B; I²C and the like. In one embodiment, control units 472 and 474 may be remote from, but operatively connected to dynamic platform 400 either wirelessly or by tethered connection. I

In one embodiment, control units 472 and 474 may be programmed remotely using a transceiver 478. Transceiver 478 may be operable to provide remote communication to and from control units 472 and 474. In certain embodiments, transceiver 478 provides communications to and from: a remote control; another automated device; remote feedback sensors, etc. In another embodiment, control units 472 and 474 may be programmed by a user interface (UI) 480 provided on dynamic platform 400. In one embodiment, UI 480 is a control panel of easily customizable hardware and software, such as a job-specific, customized graphical user interface on a touchscreen display to provide easy programming of both the LBI system and dynamic platform 400. In one embodiment, a user may input spatial coordinates of bonds in a bonded article by either transceiver 478 or user interface 480. In another embodiment, bonds may be identified by one or more dynamic platform feedback devices 482.

One or more dynamic platform feedback devices 482 are provided on dynamic platform 400 to provide feedback data to control units 472 and 474 to assist in automated operation. Dynamic platform feedback devices 482 are sensors used to gather feedback information to provide for proper automation control of dynamic platform 400. Dynamic platform feedback devices 482 may include, but are not limited to: spatial position sensors, location position sensors, displacement sensors, alignment sensors, tilt sensors, cameras, optical sensors, phototransitors, accelerometers, Global Positioning System (GPS), a laser beam profiler, magnetometers, gyroscopes, pressure sensors, gas sensors, voltage and current sensors, capacitive touch sensors, color detection, light detection, force sensors, infrared (IR) emitters/detectors, radio-frequency identification (RFID) sensors, potentiometers, thermistors, temperature and humidity sensors, ultrasonic rangefinders and echo location sensors, laser positioning, video imagining sensors and the like. In one embodiment, feedback device 482 may be an echo location sensor that will detect when a temporary or fixed object is in the inspection path of dynamic platform 400. In response to an output signal from feedback device 482, control units 472 or 474 may cut power from drive source 470 to movement device 464 to stop movement of dynamic platform 400 to prevent injury or damage. In another embodiment, an optical sensor that recognizes a patterned indicia may be used. For example, feedback device 482 may detect a patterned tape outline on the manufacturing facility floor around a test object and provide feedback to control units 472 or 474 for steering dynamic platform 400 around the test object by following the path of patterned indicia. In another embodiment, feedback device 482 may interface with sensors embedded within a facility wall, floor, and ceiling to guide dynamic platform 400 around the facility.

With reference to FIG. 5, an embodiment of automated dynamic LBI system 500 is shown. Automated dynamic LBI system 500 comprises a cabinet housing 560 containing one or more components of an LBI system, e.g., LBI system 200. Cabinet housing 560 may be operatively connected to platform 566 which may be operatively connected to chassis 562. Chassis 562 may have one or more movement devices 564 for facilitating movement of automated dynamic LBI system 500. In one embodiment, platform 566 is used to mount integral parts of the automated dynamic LBI system 500 such as an articulated arm 534 and chiller 568. Articulated arm 534 may be operatively connected to laser beam delivery system 530 and processing head 540. In one embodiment, chassis 562 is operatively connected to a lifting mechanism 584 for raising and lowering platform 566 to allow the automated dynamic LBI system to test hard to reach bonds on larger, assembled objects such as an airplane fuselage. In another embodiment, platform 566 may have a linear actuator (not shown) for linearly adjusting platform 566 relative to chasis 562.

Lifting mechanism 584 may be of any type common in the art, including, but not limited to: a scissor lift; a screw lift; one or more pneumatic, hydraulic, or mechanical actuators; a rack and pinion; a boom; a pulley system and the like.

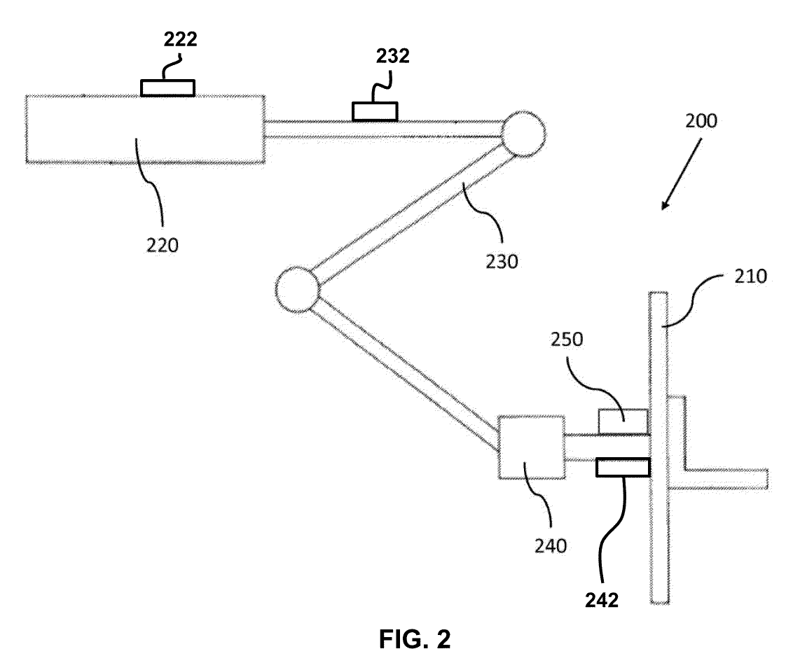

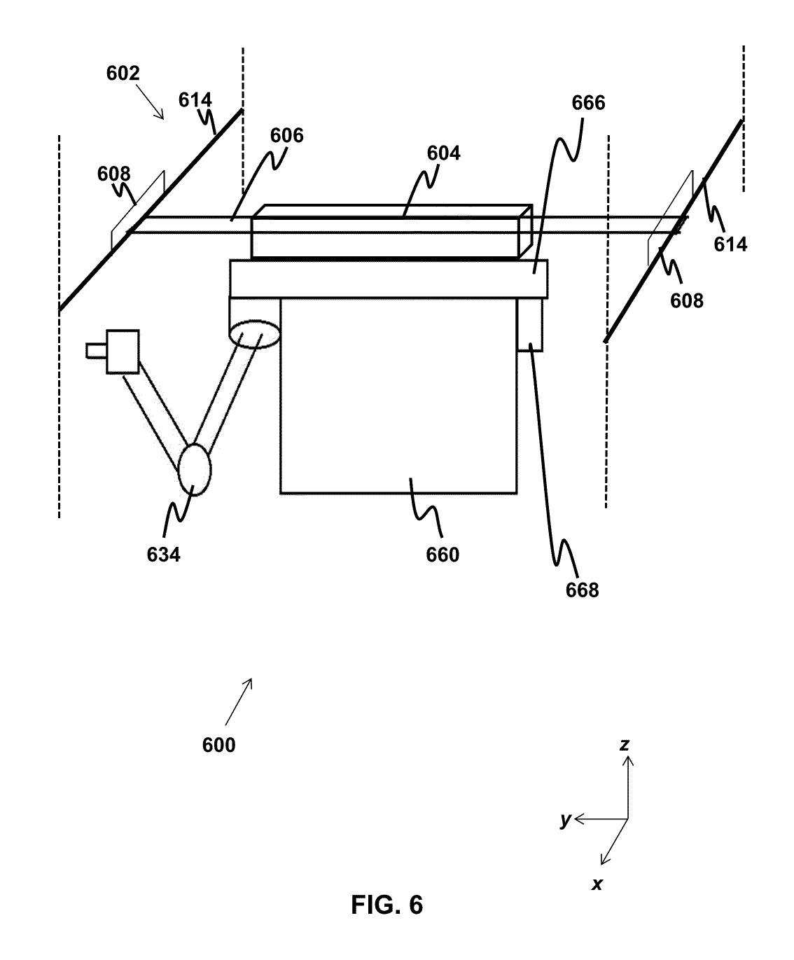

With reference to FIG. 6, an alternative embodiment of automated dynamic LBI system 600 is shown. Automated and dynamic LBI systems as described herein may either move relative to a floor, or ground surface—that is, the dynamic platform moves along the floor or ground, or move above a floor or ground. In embodiments, where dynamic platform moves above the ground or floor, an additional suspension component may be required to counteract gravity such that automated and dynamic LBI system remains attached to a wall, ceiling, or the like. In one embodiment, automated dynamic LBI system 600 comprises a cabinet housing 660 containing one or more components of LBI system 200, depicted in and described herein with respect to FIG. 2. Cabinet housing 660 is operatively connected to platform 666. In one embodiment, platform 666 is used to mount integral parts of the automated dynamic LBI system 600 such as an articulated arm 634 and chiller 668. In place of having a chassis, drive system, and lift mechanism, automated dynamic LBI system 600 may be positioned using crane 602. Crane 602 may be any type of crane common to industrial environments such as: an overhead crane; a bridge crane; a gantry crane and the like. Crane 602 may comprise a trolley 604 to control linear position in one plane (i.e. y-plane) along bridge 606, while linear motion in the plane perpendicular to bridge 606 (i.e. x-plane) may be controlled by rollers 608 which move bi-directionally on beams 614 to control a position of bridge 606 in the x-plane. Of course, a motion system of crane 602 could also include additional axes of movement beyond these Cartesian coordinates, such as pitch, yaw, tilt, and rotation. A control system of automated dynamic LBI system 600 may be used to program crane 602 for automated positioning of automated dynamic LBI system 600. In one embodiment, platform 666 may be mounted directly to trolley 604 and positioning of the automated dynamic LBI system 600 in the z-plane may be achieved by providing a lifting/lowering mechanism (not shown) to beams 614 or by providing a lifting mechanism between platform 666 and trolley 604. A lifting mechanism may include, but is not limited to: a wire and pulley, a pneumatic lift, a hydraulic lift and like mechanisms.

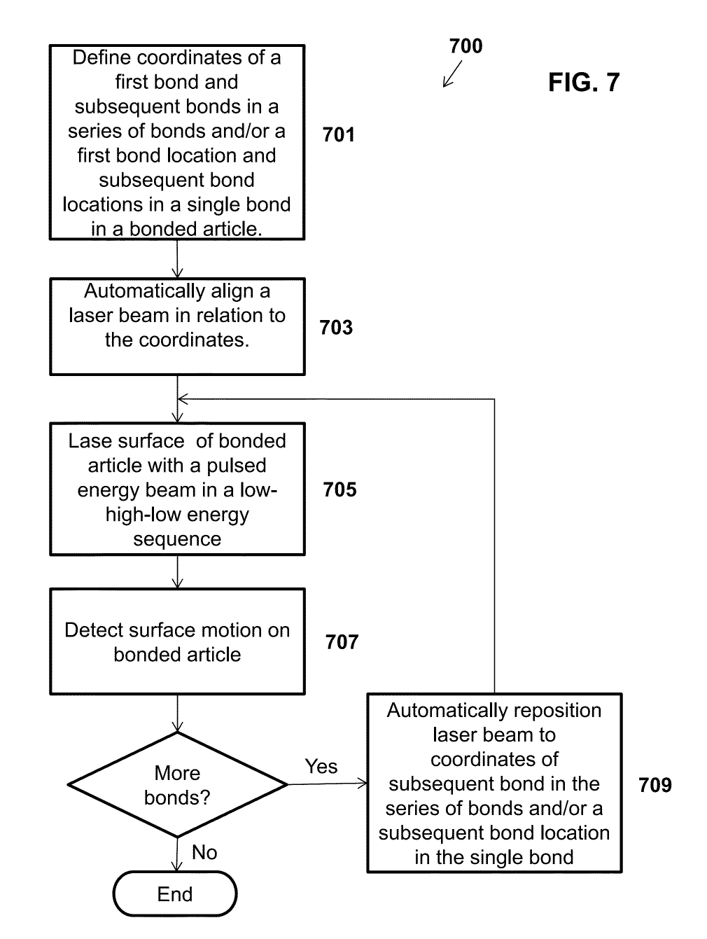

FIG. 7 is a flow chart of a method 700 for automated non-destructive testing of a bond in a bonded article. In one embodiment, method 700 may be In one embodiment, method 700 comprises: defining coordinates of a first bond and subsequent bonds in a series of bonds and/or a first bond location and subsequent bond locations in a single bond in a bonded article; (701); automatically aligning a laser beam in relation to the coordinates (703); lasing a surface of the bonded article with a pulsed laser beam in a low-high-low pulsed energy sequence, each pulse having a pulse energy of between about 3 J and about 50 J (705); detecting a surface motion on the bonded article (707); repeating steps 705 and 707 after repositioning the laser beam to the coordinates of a subsequent bond in the series of bonds and/or a subsequent bond location in the single bond (709). It is understood that the several embodiments of an automated and dynamic laser bond inspection system, as described above, may be used to perform method 700.

Unless specifically stated to the contrary, the numerical parameters set forth in the specification, including the attached claims, are approximations that may vary depending on the desired properties sought to be obtained according to the exemplary embodiments. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and apparatuses have been illustrated by describing example embodiments, and while the example embodiments have been described and illustrated in considerable detail, it is not the intention of the applicants to restrict, or in any way limit, the scope of the appended claims to such detail. It is, of course, not possible to describe every conceivable combination of components or methodologies for purposes of describing the systems, methods, and apparatuses. With the benefit of this application, additional advantages and modifications will readily appear to those skilled in the art. Therefore, the invention, in its broader aspects, is not limited to the specific details and illustrative example and exemplary embodiments shown and described. Accordingly, departures may be made from such details without departing from the spirit or scope of the general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

As used in the specification and the claims, the singular forms “a,” “an,” and “the” include the plural. To the extent that the term “includes” or “including” is employed in the detailed description or the claims, it is intended to be inclusive in a manner similar to the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. Finally, where the term “about” is used in conjunction with a number, it is intended to include ±10% of the number. In other words, “about 10” may mean from 9 to 11.

What is claimed is:

1. A system for non-destructively inspecting a bond in a bonded article, the system comprising:
a laser beam delivery system operable to deliver a laser beam for laser bond inspection of a bonded article from a laser to a workpiece, and
a dynamic platform system, operable to move the laser beam delivery system in one or more axes of translation and one or more axes of rotation.

2. An automated and dynamic system for laser bond inspection of a bond in a bonded article, the system comprising:
(1) a laser, the laser configured to generate a pulsed laser beam;
(2) a laser beam delivery system operatively connected to the laser and operable to deliver the pulsed laser beam to at least one of: a workpiece surface, and a processing head;
(3) a surface motion sensor, the surface motion sensor configured to detect a surface motion on the workpiece surface during the laser bond inspection;
(4) a dynamic platform system operable to support and move one or more components of the automated and dynamic system for laser bond inspection; and
(5) a control system comprising at least one of: one or more processors, and one or more controllers, wherein the control system is operable to execute an instruction set, process input and output signals, and control one or more components of the automated and dynamic system for laser bond inspection.

3. The automated and dynamic system for laser bond inspection of claim 1, further comprising a processing head operatively connected to the laser beam delivery system and operable to output the pulsed laser beam to the workpiece surface.

4. The automated and dynamic system for laser bond inspection of claim 3, wherein the processing head further comprises at least one of: a first output operable to output the pulsed laser beam to the workpiece surface; one or more second output operable to output at least one overlay; one or more suction ports operable to at least: remove material proximate to the workpiece surface and the processing head, and fixedly attach the processing head to the workpiece surface; and a surface motion sensor area operable to hold one or more surface motion sensors on the processing head.

5. The automated and dynamic system for laser bond inspection of claim 2, wherein the pulsed laser beam comprises at least one of: (1) a pulse energy between about 3-50 Joules per pulse; (2) a pulse width between about 70-300 nanoseconds, wherein the laser is further configured to generate laser beam pulses in a low-high-low pulse energy sequence.

6. The automated and dynamic system for laser bond inspection of claim 2, wherein the laser beam delivery system further comprises at least one of: (1) one or more mirrors; (2) a fiber optic; (3) one or more multi-axes articulated robotic arm operatively connected to at least one of: one or more laser beam delivery system components, and the processing head.

7. The automated and dynamic system for laser bond inspection of claim 2, wherein the surface motion sensor is at least one of: (1) a VISAR probe; (2) an electromagnetic acoustic transducer (EMAT) coil; (3) a capacitance probe; (4) a piezoelectric ultrasonic transducer (UT); (5) a photon Doppler velocimeter; and (6) an optical interferometer, wherein the surface motion sensor is operable to produce a signal in response to detecting surface motion.

8. The automated and dynamic system for laser bond inspection of claim 2, wherein the control system further comprises one or more sensors operable to produce a sensor signal in response a sensor measurement, the sensor signal further processable by the control system.

9. The automated and dynamic system for laser bond inspection of claim 2, wherein the dynamic platform system comprises at least one of: (1) a locomotive drive system; (2) a steering system; (3) a lifting an lower mechanism; and (4) a linear actuator, wherein a position and a movement of the dynamic platform system is controlled by the control system.

10. The automated and dynamic system for laser bond inspection of claim 2, wherein the dynamic platform system is operable to move one or more components thereon in one or more axes of translation, and one or more axis of rotation.

11. The automated and dynamic system for laser bond inspection of claim 2, wherein the dynamic platform system is operable to interface with a fixed guide system for changing a position of the dynamic platform system.

12. The automated and dynamic system for laser bond inspection of claim 11, wherein the fixed guide system is at least one of: a track, one or more rails, a cable, a lane, and an indicia.

13. The automated and dynamic system for laser bond inspection of claim 2, wherein the dynamic platform system is operable to move on one of a floor surface, and a ground surface, such that the dynamic platform system does not require an additional suspension component for movement along one of the floor surface, and the ground surface.

14. The automated and dynamic system for laser bond inspection of claim 2, wherein the dynamic platform system is operable to move above one of a floor surface, and a ground surface, such that the dynamic platform system requires an additional suspension component for movement above one of the floor surface and the ground surface.

15. The automated and dynamic system for laser bond inspection of claim 2, wherein the laser is at a fixed and remote position relative to the dynamic platform system.

16. The automated and dynamic system for laser bond inspection of claim 3, wherein the processing head is further operatively connected to a multi-axes articulated robotic arm for positioning the processing head relative to the workpiece surface.

17. A method for automated non-destructive testing of a bond in a bonded article, the method comprising:
(1) defining coordinates of a first bond and subsequent bonds in a series of bonds and/or a first bond location and subsequent bond locations in a single bond in a bonded article;
(2) automatically positioning a laser beam in relation to the coordinates;
(3) lasing a surface of the bonded article with a pulsed laser beam in a low-high-low pulsed energy sequence, each pulse having a pulse energy of between about 3 J and about 50 J;
(4) detecting surface motion on the bonded article; and
(5) repeating steps 3-4 after repositioning the laser beam to the coordinates of a subsequent bond in the series of bonds and/or a subsequent bond location in the single bond.

18. The method of claim 17, further comprising positioning and repositioning the laser beam with an automated and dynamic system for laser bond inspection.
